(19) United States
(12) Patent Application Publication
(10) Pub. No.: US 2009/0136784 A1
(43) Pub. Date: May 28, 2009

(54) MAGNETIC RECORDING DISK AND METHOD FOR MANUFACTURE THEREOF

(75) Inventors: Kota Suzuki, Tokyo (JP); Koichi Shimokawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Hoya Corporation, Shinjuku-ku (JP)

(21) Appl. No.: 12/088,803

(22) PCT Filed: Sep. 28, 2006
(86) PCT No.: PCT/JP2006/319345

§ 371 Date: Mar. 31, 2008

(30) Foreign Application Priority Data
Sep. 30, 2005 (JP) 2005-286605

(51) Int. Cl. G11B 5/71

(52) U.S. Cl. 428/846

(57) ABSTRACT

In a magnetic recording disk 1 including a magnetic layer 12, a protective layer 13, and a lubricating layer 14, the lubricating layer 14 is made from a lubricant prepared from a composition. The weight change of the lubricant ranges from −20% to −50% at 300° C. in the case where the lubricant is subjected to thermogravimetric analysis in such a manner that the lubricant is heated from 40° C. to 500° C. at a heating rate of 10° C./min. The lubricant has a maximum peak at about 300° C. in the case where the lubricant is subjected to differential thermal analysis in the same manner as described above. The lubricant can be quantitatively measured for heat resistance. Therefore, a magnetic recording disk exhibiting stable performance at high temperatures and a method for manufacturing such a magnetic recording disk can be obtained.

### TECHNICAL FIELD

The present invention relates to a magnetic recording disk and a method for manufacturing the magnetic recording disk. The present invention particularly relates to a material technology for lubricating layers.

### BACKGROUND ART

Magnetic recording disks include nonmagnetic substrates, magnetic recording layers, protective layers, and lubricating layers, these layers being arranged on the nonmagnetic substrates in that order. The lubricating layers have a function of reducing the impact of the magnetic recording disks against magnetic heads. The distance between each magnetic recording disk and magnetic head becomes narrower and narrower with an increase of a recording capacity on a magnetic recording disk drive such as a HDD. Therefore, the magnetic head may often instantaneously contact the magnetic recording disk. If the magnetic head contacts the magnetic recording disk rotating at high speed, contact portions thereof are heated to a high temperature (flash temperature) due to friction. Therefore, a recent demand is directed to a lubricant capable of forming a lubricating layer which has high heat resistance and which can prevent properties of a magnetic recording disk from being deteriorated because this lubricating layer is hardly decomposed or vaporized due to heat under such high-temperature conditions.

In order to cope with such a demand, a lubricant, such as FOMBLINE Z available from Solvay Solexis Inc., having high heat resistance and long-term stability is usually used to form lubricating layers for magnetic recording disks. The lubricant is purified such that impurities are removed from the composition or the molecular weight thereof is adjusted to an appropriate value. Weight-average molecular weight (Mw) or number-average molecular weight (Mn) has been usually used as a parameter for purification (see Patent Document 1).

Patent Document 1: Japanese Unexamined Patent Application Publication (JP-A) No. 2004-319058

It has, however, been turned out that lubricants purified using weight-average molecular weight or number-average molecular weight as a parameter do not necessarily have sufficient heat resistance at high temperatures. That is, weight-average molecular weight and number-average molecular weight are parameters unsuitable to evaluate the heat resistance of lubricants used at high temperatures.

### DISCLOSURE OF INVENTION

### Problems to be Solved by the Invention

In view of the foregoing circumstances, it is an object of the present invention to provide a magnetic recording disk including a lubricating layer, exhibiting stable performance at high temperatures, made from a lubricant. The lubricant is quantitatively measured for heat resistance.

It is another object of the present invention to provide an evaluation method for selecting a lubricant suitable for manufacturing a magnetic recording disk.

### Means for Solving the Problems

In order to achieve the above-mentioned object, according to this invention, there is provided a magnetic recording disk comprising a nonmagnetic substrate, a magnetic layer, a protective layer, and a lubricating layer, these layers being arranged on the nonmagnetic substrate in that order, wherein the lubricating layer is made from a lubricant, the weight change of the lubricant ranges from −20% to −50% at 300° C. in the case where the lubricant is subjected to thermogravimetric analysis in such a manner that the lubricant is heated from 40° C. to 500° C. at a heating rate of 10° C./min, and the lubricant has a maximum peak at about 300° C. in the case where the lubricant is subjected to differential thermal analysis in the same manner as described above.

In this invention, it is preferable that the weight change of the lubricant ranges from −25% to −40%.

In this invention, the lubricant is made from a composition containing, for example, a perfluoropolyether compound which is represented by a chemical formula below and which is a principal component. The term “principal component” used herein is defined as a component of which the content in a composition is 50 mole percent or more.

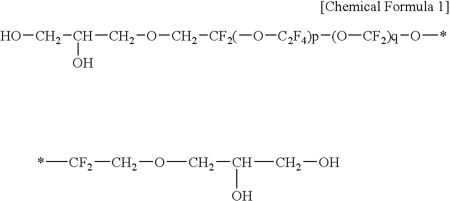

[In the above formula, p and q are natural numbers.]

According to this invention, there is provided a method for manufacturing a magnetic recording disk including a nonmagnetic substrate, a magnetic layer, a protective layer, and a lubricating layer, these layers being arranged on the nonmagnetic substrate in that order, the method comprising a step of preparing a lubricant by purifying a composition containing a perfluoropolyether compound which is a principal component and a step of forming the lubricating layer from the lubricant, wherein the weight change of the lubricant ranges from −20% to −50% at 300° C. in the case where the lubricant is subjected to thermogravimetric analysis in such a manner that the lubricant is heated from 40° C. to 5000C at a heating rate of 10° C./min, the lubricant has a maximum peak at about 300° C. in the case where the lubricant is subjected to differential thermal analysis in the same manner as described above, and the perfluoropolyether compound is represented by the following formula:

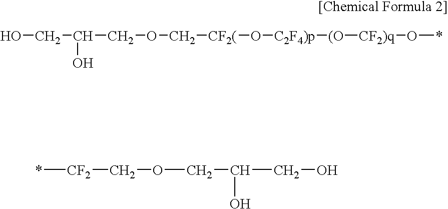

[In the above formula, p and q are natural numbers.]

### ADVANTAGES

According to the present invention, thermogravimetric analysis and differential thermal analysis are used to evaluate a lubricant; hence, the lubricant can be more precisely evaluated for heat resistance as compared to a technique using weight-average molecular weight or number-average molecular weight as a parameter before the lubricant is applied to magnetic recording disks. Therefore, if a magnetic recording disk including a lubricating layer formed from a lubricant according to the present invention contacts a magnetic head, the lubricating layer can be prevented from being thermally decomposed or vaporized. According to the present invention, the lower limit of the weight change (the lower limit of the absolute value of the weight change) of the lubricant subjected to thermogravimetric analysis is set; hence, there is an advantage that stick-slip motion is prevented in addition to thermal stability. This leads to the enhancement of the reliability of a magnetic recording disk.

### BRIEF DESCRIPTION OF DRAWINGS

FIG. 1 shows a plan view of a magnetic recording disk and a schematic sectional view of the magnetic recording disk in (A) and (B), respectively.

FIG. 2 is a schematic view of a thermogravimetric analyzer.

FIG. 3 is a schematic view of a distillation unit.

FIG. 4 is a graph showing the thermal analysis results of a lubricant.

FIG. 5 is an illustration showing the weight change of other lubricants.

### REFERENCE NUMERALS

1 magnetic recording disk
11 nonmagnetic substrate
12 magnetic layer
13 protective layer
14 lubricating layer

### BEST MODES FOR CARRYING OUT THE INVENTION

Embodiments of the present invention will now be described with reference to the accompanying drawings.

(Configuration of Magnetic Recording Disk)

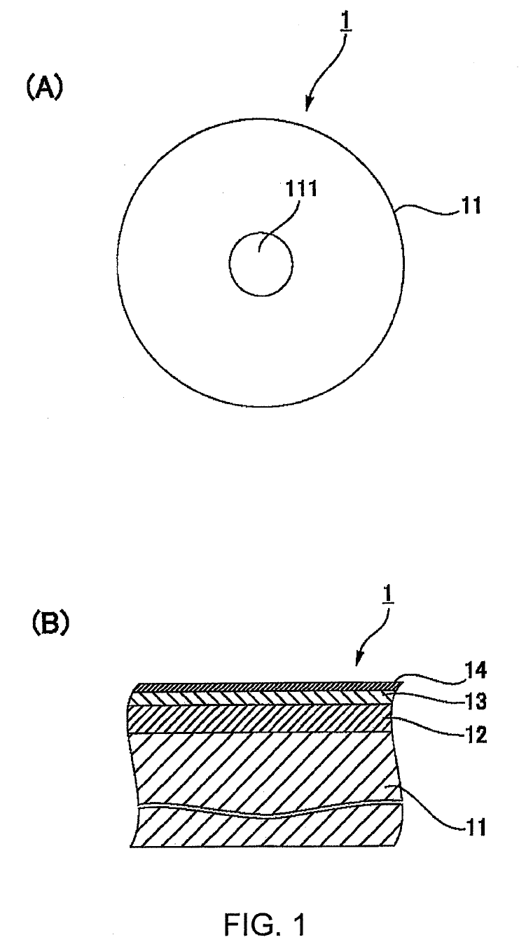

FIG. 1(A) is a plan view of a magnetic recording disk according to an embodiment of the present invention and FIG. 1(B) is a schematic sectional view of the magnetic recording disk. With reference to these figures, the magnetic recording disk 1 includes a circular nonmagnetic substrate 11 having a center hole 111, a base layer (not shown), a magnetic layer 12 formed by a DC magnetron sputtering process, a protective layer 13 formed by a plasma-enhanced CVD process, and a lubricating layer 14 formed by a dipping process, these layers being arranged on the nonmagnetic substrate 11 in that order. The nonmagnetic substrate 11 is made of, for example, chemically reinforced glass such as aluminosilicate glass. The protective layer 13 is, for example, 5 nm thick, is made of hydrogenated carbon (diamond-like carbon), and has high wear resistance and a function of protecting the magnetic layer 12. The lubricating layer 14 is, for example, 1.2 nm thick, is made of a polymeric material, and has a function of reducing the impact of the magnetic recording disk against a magnetic head. In order to form the lubricating layer 14 by the dipping process, the substrate, having the protective layer 13, for forming the magnetic recording disk is dipped into a chemical solution prepared by dissolving a predetermined lubricant in an organic solvent, removed from the chemical solution, and then heat-treated such that the lubricating layer 14 is fixed.

(Configuration of Lubricating Layer)

According to present invention, the lubricating layer 14 is formed from a lubricant evaluated and selected by thermal analysis. The principle of thermal analysis (including thermogravimetric analysis and differential thermal analysis) will now be briefly described.

(Thermogravimetric Analysis)

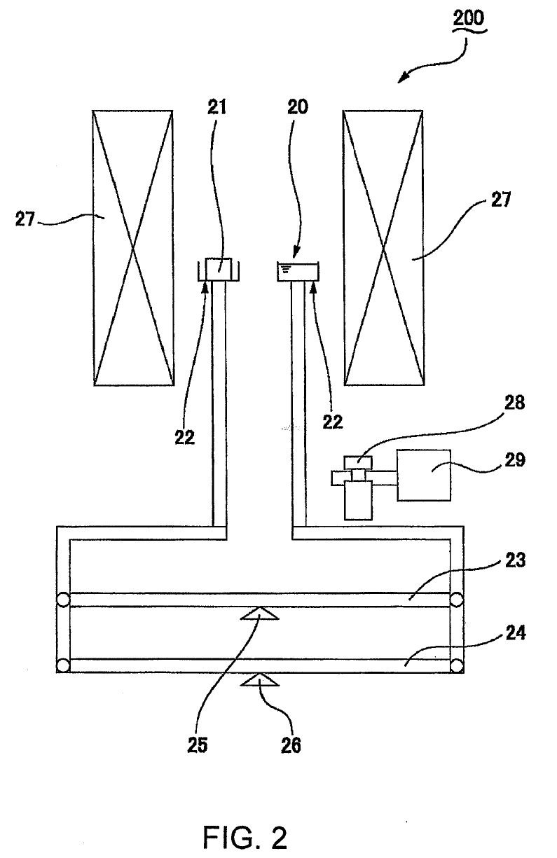

FIG. 2 is a schematic view of a thermogravimetric analyzer. Thermogravimetric analysis (TG) is such a thermal analysis technique that the weight change of a sample is measured in such a manner that the sample is heated and thereby dehydrated, thermally decomposed, or changed in another way. The thermogravimetric analyzer 200 shown in FIG. 2 is used. The thermogravimetric analyzer 200 includes a balance including a primary fulcrum 25, an auxiliary fulcrum 26, and two beams (a primary beam 23 and an auxiliary beam 24) each swinging on the primary or auxiliary fulcrum 25 or 26 and also includes sample holders 22, placed at ends of brackets of the beams, including aluminum pans. The sample holders 22 are arranged in a furnace 27. A reference material 21 is placed on one of the sample holders 22 and a sample 20 is placed on the other one. A calibration weight 28 controlled by a weight handler 29 is placed on one of the brackets on which the sample 20 is placed. These components are used to correct deviations caused by gravity, the physical change of the analyzer, or the like.

If the sample 20 is heated to a predetermined temperature in the furnace 27, the sample 20 is dehydrated, thermally decomposed, or changed in another way. This results in a change in the weight of the sample 20. The weight change of the sample 20 causes the primary and auxiliary beams 23 and 24 to be tilted to create an imbalance. The tilt of the beams is detected by a position detector (not shown) such as a photosensor. The detection of the beam tilt by the position detector allows an electromagnetic power-generating section (not shown) to be supplied with a feed-back current. The beams are moved so as to compensate the feed-back current. Since the feed-back current is proportional to the weight change of the sample 20, the weight change of the sample 20 with respect to temperature can be monitored by measuring the feed-back current. The data of the weight change of the sample 20 with respect to temperature can be converted into the derivative of the weight change of the sample 20 with respect to temperature, so that a TG curve is obtained as described below.

(Differential Thermal Analysis)

Differential thermal analysis (DTA) is such a thermal analysis technique that a sample and a material (reference material) which is thermally stable at measurement temperatures are placed in a single furnace, the furnace is heated to a predetermined temperature, and the difference in temperature between the sample and the reference material is then determined. Since the sample and the reference material are supplied with external heat under the same conditions, even a small thermal change can be detected. A DTA curve can be obtained in such a manner that obtained data is plotted on a graph such that the abscissa represents time or temperature, the ordinate represents the difference in temperature between the sample and the reference material, and a positive peak represents an exothermic process.

(Properties of Lubricant)

A first feature of this embodiment is that the weight change of the lubricant, which is used to form the lubricating layer 14, ranges from −20% to −50% and more preferably −25% to −40% at 300° C. in the case where the lubricant is subjected to thermogravimetric analysis in such a manner that the lubricant is heated from 40° C. to 500° C. at a heating rate of 10° C./min.

A second feature of this embodiment is that the lubricant, which is used to form the lubricating layer 14, has a maximum peak at about 300° C. in the case where the lubricant is subjected to differential thermal analysis in such a manner that the lubricant is heated from 40° C. to 500° C. at a heating rate of 10° C./min.

In this embodiment, the lubricant, which is used to form the lubricating layer 14, meets requirements determined by thermogravimetric analysis and differential thermal analysis; hence, the magnetic recording disk 1 has higher heat resistance as compared to that formed using a lubricant selected using weight-average molecular weight or number-average molecular weight as a parameter. Therefore, even if the magnetic recording disk 1 contacts a magnetic head, the lubricating layer 14 of the magnetic recording disk 1 can be prevented from being deteriorated due to thermal decomposition or vaporization. According to the present invention, the lower limit of the weight change (the lower limit of the absolute value of the weight change) of the lubricant subjected to thermogravimetric analysis is set; hence, there is an advantage that stick-slip motion is prevented in addition to thermal stability. Therefore, the magnetic recording disk of this embodiment has high reliability.

### EXAMPLES

The present invention will now be described in detail with reference to examples.

### Preparation of Example and Comparative Example

A lubricant according to an example of the present invention and a lubricant according to a comparative example are prepared as described below. The lubricant “Z TETRAOL” (trade name, hereinafter referred to as an unpurified lubricant) available from Solvay Solexis Inc. is used as the lubricant according to the comparative example. This composition contains a perfluoropolyether compound which is represented by a chemical formula below and which is a principal component and further contains impurities such as an inorganic ion and an organic acid. This lubricant has a wide molecular weight distribution due to the length of a primary chain and contains various functional groups.

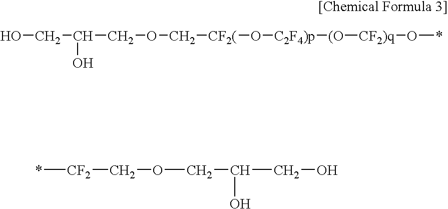

[In the above formula, p and q are natural numbers.]

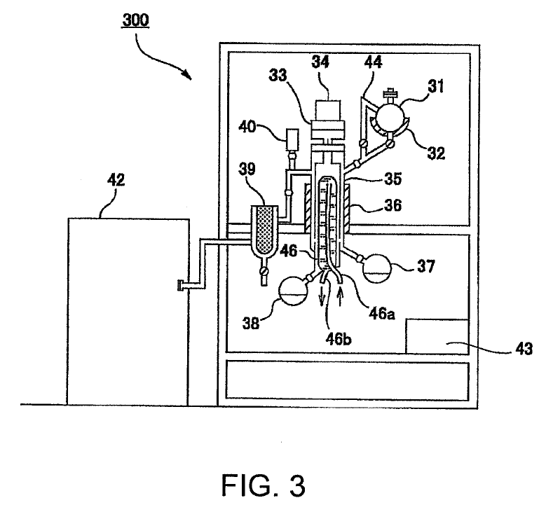

The purified composition is used as the lubricant according to the example. A principal component of the purified composition is the perfluoropolyether compound, which is represented by the above formula. Examples of a purification process used include supercritical extraction processes, gel permeation chromatography (GPC), and molecular distillation processes. A distillation unit below is used in a molecular distillation process. FIG. 3 is a schematic view of the distillation unit.

In order to purify the unpurified lubricant with the distillation unit 300 shown in FIG. 3, the unpurified lubricant is charged into a feed flask 31. Molecular distillation need not be necessarily performed under vacuum and is preferably performed under predetermined vacuum conditions in the case where a lubricant, containing a polymeric component, for magnetic recording disks is molecularly distilled. This is because if the lubricant is not molecularly distilled under vacuum, the frequency of collisions between vaporized molecules of the lubricant and other molecules is high and therefore the vaporized lubricant molecules that are within the mean free path are prevented from being condensed. Therefore, after the material is charged into the feed flask 31, the distillation unit is evacuated to a predetermined vacuum degree with an evacuation unit 42.

The vacuum degree therein is, for example, about 1×10⁻² to 1×10⁻³ Pa and is preferably less than this pressure range. The vacuum degree can be measured with a vacuum gauge 40. The material in the feed flask 31 can be degassed with the help of the negative pressure in the distillation unit in advance such that gaseous impurities and the like are removed from the material. The gaseous impurities, which are contained in the lubricant, flow toward the evacuation unit 42 through a pipe 44 and are partially trapped in a low-boiling point substance condensation trap 39. The lubricant in the feed flask 31 may be heated with a feed flask mantle heater 32 as required.

After the distillation unit is evacuated to a predetermined vacuum degree, the unpurified lubricant is fed from the feed flask 31 to a distillation column 35. The rate (feed rate) of the unpurified lubricant fed from the feed flask 31 to the distillation column 35 can be controlled by adjusting the opening of a cock 35 disposed under the feed flask 31. In usual, the feed rate thereof is preferably about 1 to 30 g/min. When the feed rate is small, it takes a long time to distillate the unpurified lubricant. When the feed rate is large, the distillation efficiency can be low.

The unpurified lubricant in the distillation column 35 is heated to a predetermined temperature with a tubular distillation column mantle heater 36 surrounding the distillation column 35. The heating temperature thereof is equal to a temperature at which the unpurified lubricant is vaporized. The heating temperature of the unpurified lubricant can be controlled by adjusting the temperature of the distillation column mantle heater 36. The heating temperature of the unpurified lubricant in the distillation column 35 can be measured with a thermometer placed in the distillation column 35.

The distillation column 35 contains a magnetic coupling agitator 33 which extends in the longitudinal direction of the distillation column 35 and which includes a wiper made of a fluororesin. The wiper is controlled with an agitator control box 34 so as to rotate at a speed of about 20 to 100 rpm in a constant direction. The rotation of the wiper allows the unpurified lubricant to form a thin film on the inner wall of the distillation column 35, thereby promoting the vaporization of the unpurified lubricant. The vapor of the unpurified lubricant contacts a cooling rod 46 placed in the distillation column 35 and therefore is liquefied. The distillate is collected in a distillate-receiving flask 38. Cooling water is introduced into an inlet port 46a located at the lower end of the cooling rod 46 and then removed through an outlet port 46. The residue, which is not vaporizable, collected in a residue-receiving flask 37 may be repeatedly distillated in such a manner that the heating temperature is changed with the distillation column mantle heater 36 and the residue is then fed into the feed flask 31. The above procedure is controlled with an operation board 43.

The lubricant according to the example was obtained using the distillation unit 300 as described below. The unpurified lubricant was charged into the feed flask 31 of the distillation unit 300 and the pressure in the distillation unit 300 was reduced to 1×10⁻³ Pa with the evacuation unit 42. The lubricant A in the feed flask 31 was sufficiently degassed with the help of the negative pressure in the distillation unit in advance such that gaseous impurities and the like were removed from the lubricant. The lubricant was fed to the distillation column 35 from the feed flask 31 at a constant feed rate. In this operation, the wiper in the distillation column 35 was operated at a predetermined rotational speed. The temperature of the distillation column 35 was 180° C. and was equal to the set temperature of the mantle heater 36. A 180° C. distillate was collected in the distillate-receiving flask 38. This distillate is hereinafter referred to as the lubricant (purified lubricant) according to the example.

(Results of Thermal Analysis)

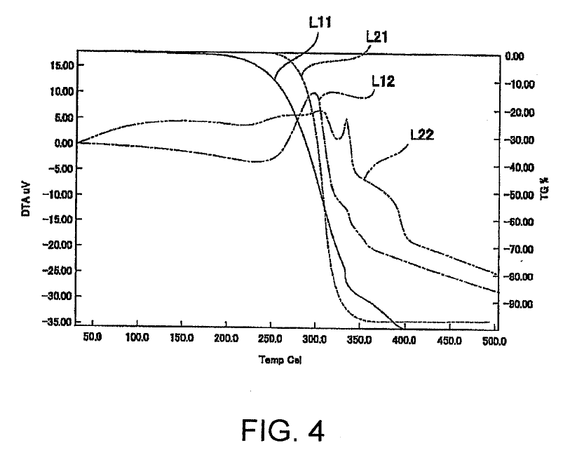

The lubricants, obtained as described above, according to the example and the comparative example were subjected to thermal analysis (thermogravimetric analysis and differential thermal analysis) in such a manner that the lubricants were heated from 40° C. to 500° C. at a heating rate of 10° C./min, whereby the results shown in FIG. 4 were obtained. In FIG. 4, the abscissa represents temperature (° C.), the right ordinate represents the results of thermogravimetric analysis (TG) (weight change (%)), and the left ordinate represents the results of differential thermal analysis (DTA) (voltage (TV) corresponding to temperature). With reference to FIG. 4, the solid line L11 represents the TG curve of the lubricant according to the example, the dotted line L21 represents the TG curve of the lubricant according to the comparative example, the one-dotted chain line L12 represents the DTA curve of the lubricant according to the example, and the two-dotted chain line L22 represents the DTA curve of the lubricant according to the comparative example.

As is clear from the thermogravimetric analysis results shown in FIG. 4, the weight change of the lubricant of the example and that of the lubricant of the comparative example are −26% and −43%, respectively, at 300° C.

As is clear from the differential thermal analysis results shown in FIG. 4, the DTA curve of the lubricant of the example has a maximum peak at about 300° C. and that of the lubricant of the comparative example has a broad peak and a maximum peak at about 340° C. A peak of a DTA curve corresponds to a temperature at which a sample is decomposed. The fact that the DTA curve of the lubricant of the comparative example has such a broad peak suggests that the lubricant thereof is decomposed over a wide temperature range.

(Evaluation Results of Magnetic Recording Disks)

The following disks were prepared and then subjected to various tests: magnetic recording disks 1 including lubricating layers 14 formed from the lubricant according to the example or the lubricant according to the comparative example. In order to form the lubricating layers 14, substrates, having protective layers 13 thereabove, for forming the magnetic recording disks were each dipped into a chemical solution prepared by dispersing the lubricant according to the example or the comparative example in the fluorine-containing solvent Vertrel XF (trade name) available from Mitsui Dupont Fluorochemical Co. The resulting substrates were heat-treated such that the lubricant was fixed to the substrates, whereby the lubricating layers 14 were formed.

The magnetic recording disks 1, prepared as described above, according to the example or the comparative example were subjected to various tests. Properties of the magnetic recording disks 1 prepared using the lubricant according to the example were prevented from being deteriorated due to the thermal decomposition or vaporization of the lubricating layers 14 even when the magnetic recording disks 1 rotating at high speed contacted magnetic heads and therefore contact portions therebetween were heated to high temperature (flash temperature) because of friction. In contrast, the lubricating layers 14 prepared from the lubricant according to the comparative example were decomposed or vaporized when the magnetic recording disks 1, prepared using the lubricant according to the comparative example, rotating at high speed contacted magnetic heads.

As described above, the lubricating layers 14 formed from the lubricant according to the example have higher heat resistance as compared to those formed from the conventional lubricant selected using weight-average molecular weight or number-average molecular weight as a parameter because the lubricant according to the example meets requirements determined by thermogravimetric analysis and differential thermal analysis. Therefore, the magnetic recording disks 1 prepared using the lubricant according to the example can be prevented from being deteriorated due to the thermal decomposition or vaporization of the lubricating layers 14 formed from the lubricant according to the example even when the magnetic recording disks 1 contact magnetic heads. The lower limit of the weight change (the lower limit of the absolute value of the weight change) of the lubricant, subjected to thermogravimetric analysis, according to the example is set; hence, there is an advantage that stick-slip motion is prevented in addition to thermal stability. This leads to the enhancement of the reliability of the magnetic recording disks 1 prepared using the lubricant according to the example.

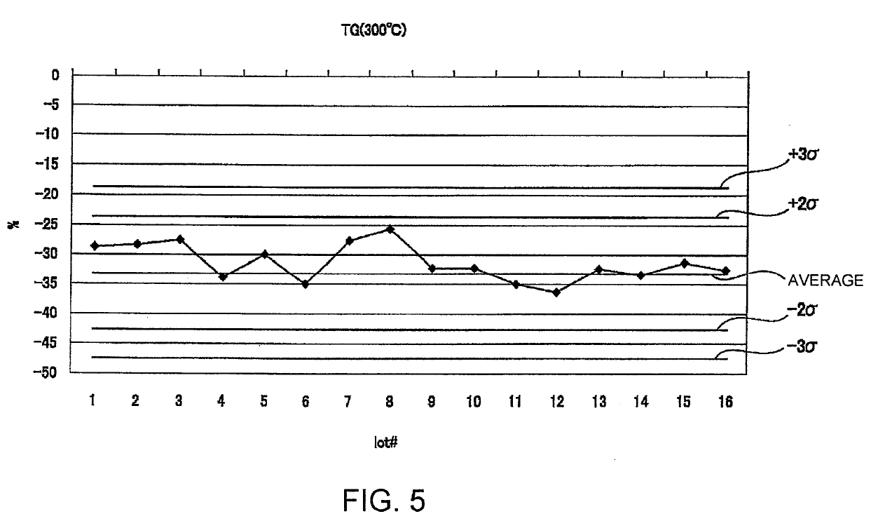

In order to specify the appropriate range of the weight change of the lubricant according to the example, various lubricants were prepared and then used to prepare magnetic recording disks 1, which were tested. This demonstrated that 16 of the lubricants (Samples 1 to 16) had good heat resistance. FIG. 5 shows the weight change of the 16 lubricants. From these results, the average ±2σ value and the average ±3σ value are determined to be as follows:
the average ±2σ value=−23% to −47%
the average ±3σ value=−18% to −48%.
   In consideration of other results, the appropriate range of the weight change of the lubricant according to the example is preferably from −20% to −50% and more preferably −25% to −40%. Lubricants having a weight reduction greater than the above range have low heat resistance. This is probably because the lubricants contain molecules with low molecular weight, impurities causing decomposition, and/or the like. The use of lubricants having a weight reduction less than the above range may cause the stick-slip motion of magnetic heads. This is probably because these lubricants contain a large amount of compounds with high molecular weight and therefore have an extremely large friction coefficient. The use of the results of thermogravimetric analysis as parameters illustrates the molecular weight distribution of a lubricant that have an influence on the heat resistance and the like of the lubricant, the state of a terminal group of the lubricant, and information about contamination. Accordingly, if a lubricant with high heat resistance is selected on the basis of the results of thermogravimetric analysis, this lubricant has good molecular weight distribution, has a terminal group in good condition, and is uncontaminated.

(Other Examples)

The configurations (shape, size, and arrangement) used to describe the above example are merely schematically shown in the figures such that the present invention can be understood and practiced. Numbers and compositions (materials) used to describe the configurations are for exemplification only. The present invention is not limited to an embodiment below and modifications may be made within the scope of the inventive concept disclosed in the appended claims. The perfluoropolyether lubricant (the lubricant “Z TETRAOL” (trade name) available from Solvay Solexis Inc.), which principally contains a tetraol, is used as a starting material for preparing the lubricant according to the example. A compound with a terminal group having at least one selected from the group consisting of a diol structure, a triol structure, and a tetraol structure may be used to prepare the lubricant.

1. A magnetic recording disk comprising a nonmagnetic substrate, a magnetic layer, a protective layer, and a lubricating layer, these layers being arranged on the nonmagnetic substrate in that order,
wherein the lubricating layer is made from a lubricant, the weight change of the lubricant ranges from −20% to −50% at 300° C. in the case where the lubricant is subjected to thermogravimetric analysis in such a manner that the lubricant is heated from 40° C. to 500° C. at a heating rate of 10° C./min, and the lubricant has a maximum peak at about 300° C. in the case where the lubricant is subjected to differential thermal analysis in the same manner as described above.

2. The magnetic recording disk according to claim 1, wherein the weight change of the lubricant ranges from −25% to −40%.

3. The magnetic recording disk according to claim 1, wherein the lubricant is prepared from a composition containing a perfluoropolyether compound which is a principal component and which is represented by the following formula: 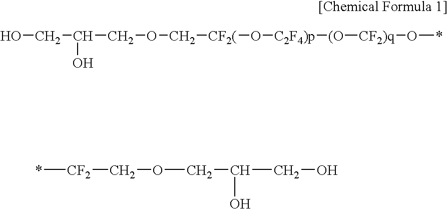
[In the above formula, p and q are natural numbers.]

4. A method for manufacturing a magnetic recording disk including a nonmagnetic substrate, a magnetic layer, a protective layer, and a lubricating layer, these layers being arranged on the nonmagnetic substrate in that order, the method comprising a step of preparing a lubricant by purifying a composition containing a perfluoropolyether compound which is a principal component and a step of forming the lubricating layer from the lubricant,
wherein the weight change of the lubricant ranges from −20% to −50% at 300° C. in the case where the lubricant is subjected to thermogravimetric analysis in such a manner that the lubricant is heated from 40° C. to 500° C. at a heating rate of 10° C./min, the lubricant has a maximum peak at about 300° C. in the case where the lubricant is subjected to differential thermal analysis in the same manner as described above, and the perfluoropolyether compound is represented by the following formula: 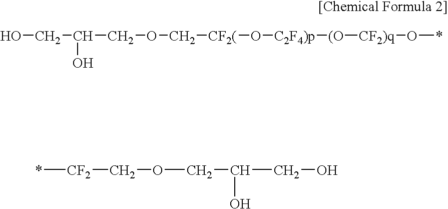
[In the above formula, p and q are natural numbers.]

5. The magnetic recording disk according to claim 2, wherein the lubricant is prepared from a composition containing a perfluoropolyether compound which is a principal component and which is represented by the following formula: 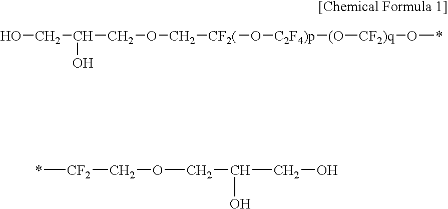
[In the above formula, p and q are natural numbers.]
